(19) United States
(12) Patent Application Publication
(10) Pub. No.: US 2013/0056561 A1
(43) Pub. Date: Mar. 7, 2013

(54) Drip Irrigation System and Apparatus for Installation Thereof

(71) Applicant: Larry Freels, Madera, CA (US)

(72) Inventor: Larry Freels, Madera, CA (US)

(21) Appl. No.: 13/226,240

(22) Filed: Sep. 6, 2011

(51) Int. Cl. B05B 15/00; B23P 19/00

(52) U.S. Cl. 239/542; 29/428

(57) ABSTRACT

An improved drip irrigation system and apparatus for installation of the irrigation system. The new irrigation system comprises an emitter line which is buried along the length of a trench that encircles a plant hole in which a plant is received. The emitter line connects to a water distribution line to more efficiently and effectively deliver water to the roots of the plant by discharging water into the trench. The emitter line, which is placed inside an outer pipe, has a plurality of emitters that discharge water into the interior of the outer pipe. Water flows to the roots through discharge openings in the pipe. The new apparatus has plant hole and trench forming tools configured to simultaneously dig the plant hole and cut the trench around the plant hole, a mechanism to rotate the tools and a mechanism to raise and lower a frame which supports the tools.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to irrigation systems that utilize a plurality of irrigation lines to deliver water to trees, vines and other plants and to apparatuses utilized for installation of those irrigation systems. More specifically, the present invention relates to drip irrigation systems that deliver water directly to the plants and to apparatuses which are beneficially configured to facilitate installation of the drip lines at the plants. Even more particularly, the present invention relates to drip irrigation systems that more efficiently and effectively deliver water and apparatuses which ease and reduce the cost of installation of such systems.

B. Background

Irrigation systems have generally been in use for thousands of years to deliver water to trees, vines and other plants. Older systems often comprised canals, trenches, furrows and other open delivery conduits. A relatively recent improvement on irrigation systems, but which has been in use for many years, are systems known as drip irrigation systems. These systems are configured to more specifically direct water to the plant or plants where irrigation is desired. Drip irrigation systems better control the use and placement of water than non-drip irrigation systems by precisely placing the water at the plants where it is needed. In addition, drip irrigation systems are often specifically configured to allow for irrigation with very low flow rates. As a result, drip irrigation systems generally require somewhat less water than non-drip irrigation systems, which makes it particularly popular in the more arid regions of the world.

Drip irrigation systems connect to a source of water and distribute a controlled quantity of that water through a distribution line. The typical distribution line is a linear tubing made out of polyethylene, polyvinylchloride (PVC) and like materials. The distribution line can be open at the distal end to deliver water to plant at the end of the line, often used with a device to keep bugs and debris from entering the line, or the line can be closed at its distal end and utilize flow control devices, commonly known as drip emitters, along the distribution line in a series arranged at the general position of the plants to be irrigated. Water flows from the source through the distribution line towards the plants to be watered by that line, exiting the line at the end of the distribution line or through the emitters placed along the line.

The typical drip irrigation system has multiple distribution lines and a water distribution apparatus, typically a manifold or like device, to distribute water to the various distribution lines. The water distribution apparatus is utilized to prevent non-selective flow disparity between the distribution lines, which would otherwise result from pressure disparity between the various lines and emitters in the lines, so as to ensure the delivery of water to the plants that are reflective of that which is the most beneficial for the plants. Typically, the distribution lines for emitter systems are placed on top of the surface of the ground along one side of the plant with the emitter being generally adjacent the plant.

As an alternative to emitters, many irrigation systems use relatively low volume, spray-type sprinklers, commonly referred to as microsprinklers or microsprayers, to spray water on and/or around the plants. As with drip emitters, pressurized water for the microsprinklers is typically delivered through a plurality of distribution lines. Compared to drip emitters, microsprinklers generally provide for much higher flow rates and they can irrigate a much wider area around the plant, which is particularly important for trees or other types of vegetation that have relatively large root systems. Compared to conventional larger flow rate sprinklers, microsprinklers are much more energy and water efficient because they generally deliver less water at lower pressure with the water being directed more specifically at the location where it is needed, which can also provide for more precise micronutrient delivery. Microsprinklers provide a spray of water that has droplets which are much smaller than the droplets provided by conventional sprinklers, resulting in more of the water being absorbed into the soil and less of the water creating runoff problems. Microsprinklers are commonly utilized in under canopy irrigation in fruit orchards, vineyards and green houses. As with conventional sprinklers, the microsprinklers need to be at least slightly elevated above the ground, typically four to eight inches, in order to avoid rocks, weeds or other obstructions and achieve the desired spray pattern. One common method of elevating microsprinklers is to attach them to a stake or spike that has a pointed end which is inserted into the ground. As with drip emitter irrigation systems, the distribution lines that connect to the various microsprinklers are generally placed on top of the surface of the ground. One disadvantage of the use of microsprinklers is that the spray of water therefrom can also water weeds or other undesirable vegetation around the desired plant and the spray can result in relatively higher humidity levels around the plants, which is harmful to some plants. To avoid and treat the undesirable vegetation, chemicals are commonly added to the water to kill or prevent growth of that vegetation.

As is well known, most sources of water that are utilized for irrigation and other purposes are likely to contain particles and contaminants that can plug up the distribution lines, the emitters disposed therein and/or the microsprinklers attached thereto. One type of contaminant which is commonly found in irrigation water is particulate matter, particularly silt and sand particles. Another type of contaminant that can be present in irrigation or other water distribution systems is biological (i.e., bacterial slimes, algae and etc.) and/or chemical precipitate. These potential clogging issues can arise from materials that are in the source water or growing in or a result of the irrigation or other distribution system. To reduce clogging from particulate, biological and/or chemical precipitate matter, most irrigation systems utilize some type of filtering or chemical maintenance system to keep such matter away from the distribution lines, emitters and microsprinklers. In fact, most emitter and microsprinkler manufacturers specify a filter mesh size that should be used to filter the water prior to entering the distribution lines.

Another problem for microsprinklers is clogging caused by external debris and/or insects and the like that get into the microsprinkler nozzle(s) or interfere with the microsprinkler's spray pattern. In order to have an output spray that is of sufficient velocity to achieve the desired spray range in a low pressure system, microsprinklers utilize a nozzle that has a small output aperture. As is well known to those skilled in the art, these small nozzle apertures can be easily, and often are frequently, clogged by insects. In addition to clogging the nozzles, debris and insects (as well as particulate, biological and/or chemical precipitate matter) can interfere with the operation of the internal components, including those that are utilize to achieve spinning, rotating or other features, of the microsprinkler. Whether due to the apertures being clogged or the internal components ceasing to function, the desired water distribution effectiveness of a microsprinkler can be significantly reduced or even substantially eliminated, which can create stress and other water deprivation problems for the plant which depends on the microsprinkler to deliver water on a regular basis.

When a microsprinkler becomes clogged with particulate, biological and/or chemical precipitate matter, debris or insects, the user must clean or arrange for the microsprinkler to be cleaned. Although many microsprinklers are configured to be taken apart for cleaning or repair in the field, these operations are made somewhat difficult by the numerous small components that make up the nozzle and/or spray pattern of the microsprinkler. It is not uncommon for the user to lose a necessary component when he or she is trying to clean or repair the microsprinkler, thereby rendering the microsprinkler ineffective until the missing component can be replaced. Even without losing a component, the handling of the small spinners, deflectors and/or other components can make the cleaning or repair operation somewhat time consuming.

What is needed, therefore, is an improved drip irrigation system that has the low flow and controlled placement benefits of emitter systems and the improved distribution of microsprinkler systems, particularly with regard to trees and other “permanent” plants, without the clogging and malfunctioning problems common for such systems. The improved drip irrigation system should require less water use, by providing higher water distribution efficiency and effectiveness at the plants, than conventional low volume irrigation systems. Preferably, an improved drip irrigation system will be configured to substantially eliminate the unintentional watering of weeds or other undesirable vegetation around the desired plant, which commonly results from use of microsprinkers, thereby lessening or even eliminating the need to use chemicals to prevent or kill the undesirable vegetation. The improved irrigation system should generally utilize conventional drip irrigation components and be relatively easy and inexpensive to install.

What is also needed, is an apparatus that is useful for installing an improved drip irrigation system. The improved apparatus should be configured to facilitate placement of irrigation drip lines substantially around the location where the desired tree or other plant will be located. Preferably, the improved apparatus should allow relatively quick, precise and cost efficient installation of the irrigation distribution lines.

### SUMMARY OF THE INVENTION

The drip irrigation system and apparatus for installation thereof of the present invention solves the problems and provides the benefits identified above. That is to say, the present invention discloses a new and improved drip irrigation system that provides for more efficient and effective watering of trees and other plants and an apparatus for installation of the new system. The drip irrigation system of the present invention is configured for low flow rate water distribution through a plurality of distribution lines to a plurality of plants that benefit from the distribution of water thereto without the clogging and malfunctioning problems commonly associated with other low flow rate irrigation systems, particularly those using microsprinklers. Through improved water distribution efficiency and effectiveness, the drip irrigation system of the present invention requires less water, for the same plants and growing conditions, than conventional low volume irrigation systems. In the irrigation system of the present invention, the portion of the drip line with the emitters is buried beneath the ground and positioned so as to be substantially encircling the plant, which significantly reduces or eliminates the watering of weeds or other undesirable vegetation and lessens the need to use chemicals to prevent or kill the undesirable vegetation. The new irrigation system generally utilizes conventional drip irrigation components and is relatively easy and inexpensive to install.

To facilitate installation of the improved irrigation system, the present invention also includes an apparatus that is particularly configured to dig a trench that encircles the location where the tree or other plant will be planted so the emitter portion of the drip line can be positioned therein. The new apparatus provides for relatively quick, precise and cost efficient installation of the emitters around the planned planting location by digging the planting hole and cutting a generally circular trench around the planting hole for placement of the emitter portion of the drip line therein. In a preferred embodiment of the apparatus of the present invention, the apparatus simultaneously digs the plant hole and cuts the circular trench.

In one general aspect of the present invention, the drip irrigation system comprises a source of water, one or more distribution lines hydraulically connected to the source of water to distribute water throughout a planting area, a plurality of plant locations in the planting area that each have a ground surface with a trench and a plant hole disposed therein, an outer pipe that is buried along the length of the trench at the trench bottom thereof and an emitter line which is disposed in the interior of the outer pipe and configured to discharge water to the interior of the outer pipe. The outer pipe has discharge openings therein that are configured to allow water to flow from the interior of the pipe to the soil in the trench. The emitter line is hydraulically connected to the distribution lines so as to distribute water to the roots of the plant through the discharge openings in the outer pipe. The trench defines a watering shape around the plant hole such that the trench is at least generally associated with the roots of the plant in the plant hole. In the preferred embodiment, the trench has a circular watering shape such that each of the emitter line and outer pipe substantially encircle the plant hole to deliver water to the roots on all sides of the plant. In a preferred embodiment, the emitter line has a plurality of discharge apertures that each have a discharge device, such as a low flow rate emitter, associated therewith to discharge water from the emitter line into the interior of the outer pipe. Preferably, the plant hole is disposed substantially at or near a center location of the watering shape, with the trench and the plant hole being formed simultaneously by the new apparatus of the present invention.

In one general aspect of the present invention, the apparatus for use in installing the above-identified drip irrigation system comprises a frame having a plurality of frame members, a plant hole forming tool that is rotatably supported by the frame, a trench forming tool which is also rotatably supported by the frame, a rotating mechanism supported by the frame and operatively connected to each of the plant hole forming tool and the trench forming tool so as to rotate the plant hole forming tool and the trench forming tool relative to the frame and a vertical support mechanism which connects the frame to an operating section of the apparatus and is configured to raise and lower the frame so as to respectively disengage or engage the plant hole forming tool and/or the trench forming tool with the ground surface at a plant location where a plant is to be located. The plant hole forming tool is configured to engage the ground surface and form a plant hole in the ground surface that is sized and configured to receive the plant therein. The trench forming tool is configured to engage the ground surface at the plant location and form a trench in the ground surface substantially around the plant hole. The trench has a trench bottom to support an emitter line, which is disposed inside an outer pipe, that is hydraulically connected to one or more distribution lines so as to discharge water into the trench and to the roots of the plant. The trench defines a watering shape, which in the preferred embodiment is circular such that the emitter line and outer tube substantially encircle the plant hole to deliver water to all sides of the roots of the plant. To provide the circular watering shape, the trench forming tool has a circular shaped tool body. One or more trench shaping blade members extending outwardly from the tool body to shape the contours of the trench. In the preferred embodiment, the trench forming tool also has a plurality of replaceable cutting blades at a lower end of the tool body, with each of the cutting blades extending below a lower edge of the tool body so as to cut the trench into the ground surface upon rotation of the trench forming tool. In one embodiment, the operating section of the apparatus comprises an operator area that is configured to allow an operator to move the apparatus and operate the rotating and vertical support mechanisms, a power device configured to supply power to the apparatus and to the rotating and vertical support mechanisms and a mobile carriage that is configured to allow the apparatus to move to the plant location to form the plant hole and trench.

Accordingly, the primary objective of the present invention is to provide an improved drip line irrigation system and an apparatus for installation of that system that provides the advantages discussed above and overcomes the disadvantages and limitations associated with presently available drip irrigation systems and apparatuses for installing such systems.

It is also an important object of the present invention to provide an improved drip irrigation system that more efficiently and effectively waters trees and other plants, thereby requiring less water, than present drip irrigation systems and an apparatus that facilitates installation of the new drip irrigation system.

It is also an important object of the present invention to provide an improved drip irrigation system that has the emitter portion of the distribution lines under the surface of the ground and positioned so as to substantially encircle the plant and provide an apparatus that quickly and easily digs the plant hole that will receive the plant and the trench around the plant that will receive the emitter portion of the distribution line.

It is also an important object of the present invention to provide an improved drip irrigation system in which the portion of the drip line having the emitters is buried beneath the ground and positioned to be substantially encircling the plant so as to significantly reduce or even eliminate watering of weeds and/or other undesirable vegetation and, therefore, lessen the need to use chemicals to prevent or kill the undesirable vegetation.

It is also an important object of the present invention to provide an improved drip irrigation system that utilizes conventional drip irrigation components and is relatively easy and inexpensive to install.

It is also an important object of the present invention to provide an apparatus useful for facilitating the installation of a drip irrigation system having the emitter portion of the distribution line buried beneath the soil and positioned substantially around the plant which is watered.

It is also an important object of the present invention to provide an apparatus useful for digging a plant hole in which the tree or other plant will be placed and cutting a trench that at least substantially encircles the plant hole for receiving the emitter portion of the distribution line.

It is also an important object of the present invention to provide an apparatus useful for simultaneously digging a plant hole in which a tree or other plant will be placed and a cutting a trench that at least substantially encircles the plant hole for receiving the emitter portion of the distribution line.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top plan view of a drip irrigation system configured according to a preferred embodiment of the present invention, showing a plurality of plant locations laid out in rows throughout an orchard with the plant locations shown in various stages of completion;

FIG. 2 is a top plan view of a plant location which will be utilized in the drip irrigation system of the present invention with the plant location shown in its initial stage of completion having a plant hole and circular trench around the plant hole;

FIG. 3 is a top plan view of the plant location of FIG. 2 shown with an emitter line disposed substantially inside an outer tube that is positioned in the circular trench with the emitter line shown connected to a distribution line;

FIG. 4 is a top plan view of the plant location of FIG. 3 shown with the outer tube, having the emitter line therein, buried below the surface of the ground;

FIG. 5 is a top plan view of the plant location of FIG. 4 shown with the plant positioned in the plant hole;

FIG. 6 is a cross-sectional side view of the plant location of FIG. 5 taken through lines 6-6 of FIG. 5 showing the outer tube positioned below the surface of the ground and the emitter line inside the outer tube;

FIG. 7 is a side view of a section of the outer tube showing the emitter line therein with the emitter inside the emitter line;

FIG. 8 is a side perspective view of an apparatus that is configured according to a preferred embodiment of the present invention for use to install the drip irrigation system of FIG. 1 by digging the plant hole and cutting the circular trench shown in FIG. 2;

FIG. 9 is a front view of the trench forming tool of the apparatus of FIG. 6 showing the plant hole forming tool disposed generally in the center thereof;

FIG. 10 is an isolated view of the lower end of the trench forming tool of FIG. 9 viewed from the exterior of the tool body showing the trench shaping members and cutting blades thereon; and

FIG. 11 is an isolated view of the lower end of the trench forming tool of FIG. 9 viewed from the interior of the tool body showing the cutting blade removably attached to the tool body.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, the figures and description provided herein are primarily directed to an orchard having a plurality of trees that are irrigated by the system of the present invention, however, those skilled in the art will readily understand that this is merely for purposes of simplifying the present disclosure and that the present invention is not so limited as the system and apparatus of the present invention can be utilized with a variety of different plants.

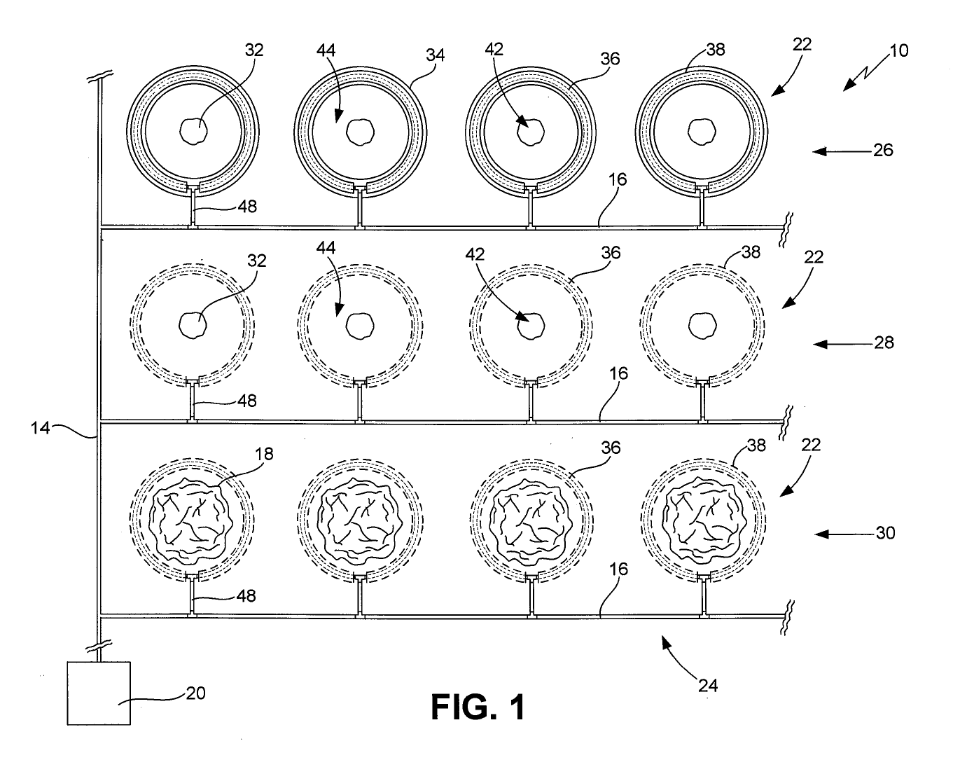

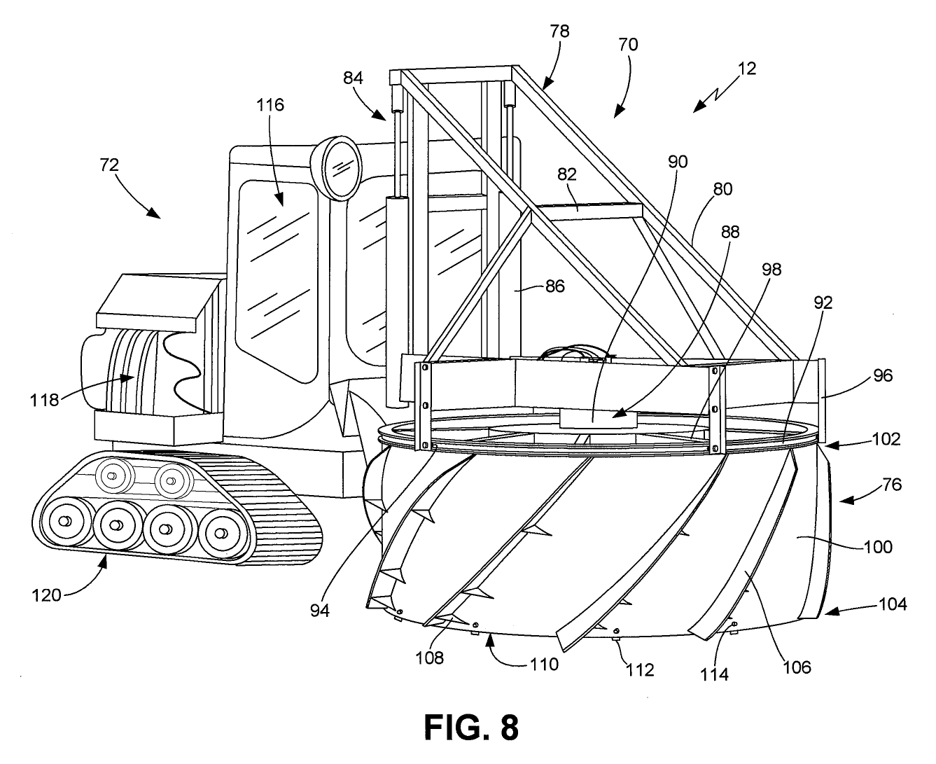

An improved drip irrigation system that comprises the components of and which is configured pursuant to a preferred embodiment of the present invention is shown generally as 10 in FIG. 1. An apparatus that is useful for the installation of the improved drip irrigation system 10 and which comprises the components of and which is configured pursuant to a preferred embodiment thereof is shown generally as 12 in FIG. 8. As best shown in FIG. 1, the drip irrigation system 10 of the present invention generally comprises one or more water distribution lines, such as primary distribution line 14 and the secondary distribution lines 16 spread out through a field or orchard to deliver water to one or more plants 18 from a source of water 20. In FIG. 1, the plants 18 are trees which are positioned in rows in an orchard. Associated with each plant 14 is a plant location 22, which is where the plant 18 will be planted and water will be delivered via distribution lines 14/16. In a typical prior art drip irrigation system, the secondary lines 16 would be placed in the row of plants generally adjacent one side of the plants 18 with either an emitter or microsprinkler, as applicable, positioned inside or attached to the secondary lines 16 at each plant location 11 where a plant 18 will grow. In the prior art emitter configuration, water from the source of water 20 exits the secondary line through an aperture in the secondary line 16. At least the secondary lines 16 are positioned on top of the surface of the ground so water will discharge from the emitter, through the aperture, to percolate into the ground to the root system of the plant 18. In the prior art microsprinkler configuration, which is particularly applicable for use with trees due in part to their relatively larger root system and the need for greater amounts of water, water is sprayed towards the plant 18 from the microsprinkler in a manner that applies water to a larger area of the ground. As with water from the emitters, water from the microsprinklers also percolates into the ground and to the roots. As set forth in the Background, it is relatively common for microsprinklers to become clogged or to otherwise malfunction.

As set forth in more detail below, system 10 of the present invention also utilizes emitters to discharge water to the plants 18, however the emitters are not disposed in the secondary lines 16. Instead, the emitters utilized with the drip irrigation system 10 are disposed in separate lines, which connect to secondary lines 16, that are buried below the surface of the ground and, in a preferred embodiment, encircle or at least substantially encircle the plants 18 so that water from the source of water 20 will water the plants 18 to facilitate growth thereof. As further set forth below, burying the lines having the emitters below the surface of the ground has benefits with regard to watering the plants 18 and operating the field, orchard or other area in which the plants 18 are growing.

An exemplary embodiment of the drip irrigation system 10 of the present invention is shown in FIG. 1. In this embodiment, which is generally believed to be a preferred embodiment, a plurality of plant locations 22 are located in a planting area 24. For purposes of describing the system 10 of the present invention, the planting area 24 shows three rows, identified as first row 26, second row 28 and third row 30, of plant locations 22 in various stages of completion, from the initial preparation stage to the plant growing stage. As will be readily appreciated by persons skilled in the art, however, normally each of the rows 26/28/30 would be at or substantially near the same stage of completion (e.g., from initial to plant growing) at substantially the same time. The first row 26 shows a plurality of plant locations 22 at a relatively early stage of completion with each plant location 22 having an empty plant hole 32, that is sized and configured to receive a plant 18 therein (shown prior to receiving plant 18), an open trench 34 around the plant hole 32 and an emitter line 36 inside and along the length of trench 34. In the embodiment shown in FIG. 1, the emitter line 36 is shown as being disposed inside a perforated outer pipe 38, the trench 34 is shown as having a generally circular watering shape 40 and the plant hole 32 is disposed at or near the center location 42 of the circular trench 34. As set forth in more detail below, the plant hole 32 and trench 34 are dug or cut out of the ground surface 44 to receive the plant 18 and emitter line 36 and outer pipe 38, respectively, and the outer pipe 38 is positioned on a trench bottom 46 disposed below the ground surface 44 to distribute water from the source of water 20 to the plant 18. Each of the emitter lines 36 are hydraulically connected to the secondary lines 26 by a connecting line 48, which is shown as being laterally disposed relative to its respective secondary line 26 in FIGS. 1 and 3 through 5, by a pair of T-shaped line connectors, shown as first line connector 50 and second line connector 52, as best shown in FIGS. 3 through 5. As will be readily appreciated by persons skilled in the art, although the layout of the planting area 24 in FIG. 1 shows each of the primary lines 14, secondary lines 16 and connecting lines 48 as being substantially perpendicular or parallel to each other, as applicable to FIG. 1, the layout of the planting area 24 can generally take on any configuration that may be suitable or desirable for the plants 18 and/or planting area 24 and the direction of each of these lines 14/16/48 can be non-uniform, such as having different angles or being curved, relative to each other.

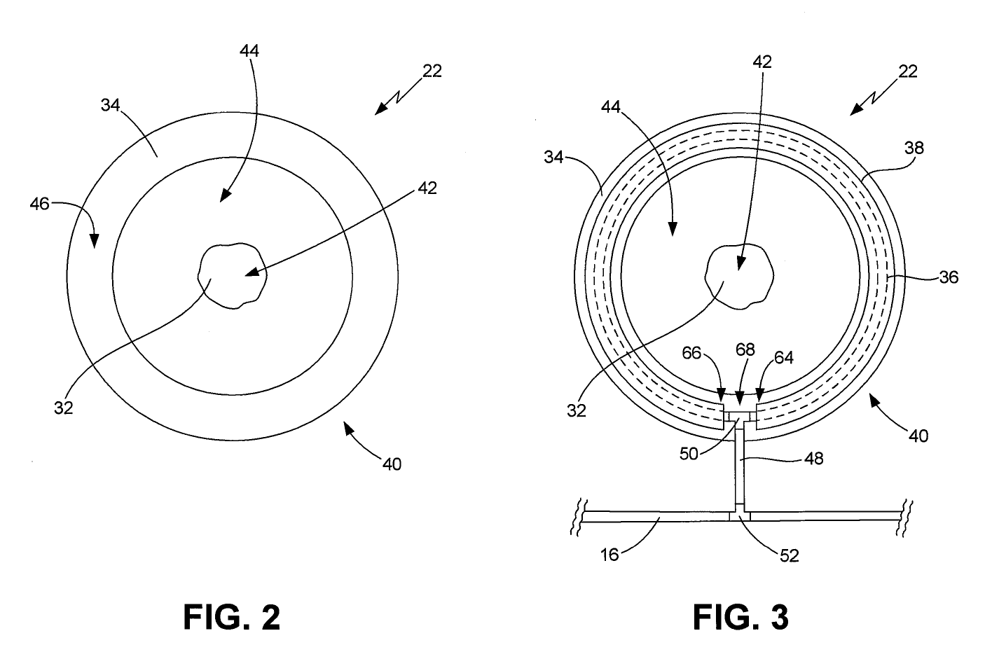

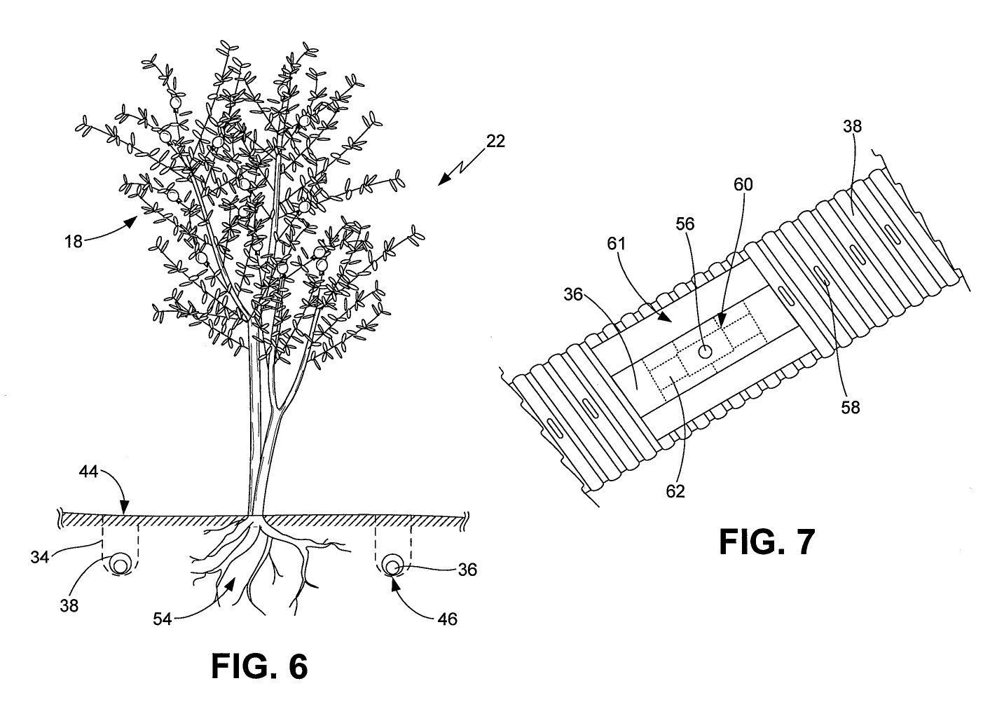

The second row 28 of the planting area 24 of FIG. 1 shows each of the plant locations 22 with the trench 34 after it was covered up with soil or other material (therefore not shown in row 28) so as to bury emitter line 36 and outer pipe 38 against the trench bottom 46 and below the ground surface 44 so system 10 may more efficiently and effectively deliver water to the roots 54 of plant 18, as best shown in FIG. 6. The third row 30 of the planting area 24 of FIG. 1 shows each of the plant locations 22 with a plant 18 received in the plant hole 32, with the plant 28 shown after having grown over time, so as to receive water from the source of water 20 through the distribution lines 14/16, connecting line 48 and the emitter line 36. As set forth in more detail below, each of the emitter lines 36 have one or more emitter apertures 56 through which water flows out of emitter line 36 into the outer pipe 38 and each of the outer pipes 38 have one or more discharge openings 58 through which the water flows from the outer pipe 38 to the soil around the now filled-in trench 34 and to the roots 54 of the plant 18 growing at the respective plant location 22, as shown in FIG. 7. In a preferred embodiment of system 10, each of the emitter lines 36 has a plurality of emitter apertures 56 therein with a discharge device 60, such as a low flow rate emitter 62, in the emitter lines 36 at or otherwise associated with each emitter aperture 56 and the outer pipe 38 has a plurality of discharge openings 58 along the entire length of outer pipe 38. The drip irrigation system 10 of the present invention of FIG. 1 set forth above is described in more detail below with regard to FIGS. 2 through 7.

Initially, the planting area 24 will be prepared so as to establish one or more plant locations 22 throughout the planting area 24, with each planting area 22 having a ground surface 44 associated therewith. A plant hole 32 and trench 34 are disposed in the ground surface 44. In one embodiment, the plant hole 32 and trench 34 are formed by use of the apparatus 12 shown in FIG. 8 and described below. The plant hole 32 is sized and configured to receive a plant 18 therein. Although a wide variety of plants 18 can benefit from the drip irrigation system 10 of the present invention, typically the system 10 will be utilized with relatively permanent plants such as trees, for instance almond, pistachio, pomegranate, orange and other trees having produce grown commercially, and the like. The trench 34 will define a watering shape 40 at the plant location 22 such that the trench 34 is associated with the plant 18 when the plant 18 is in the plant hole 32 and in a manner that facilitates water from the trench 34 being able to beneficially reach the roots 54 of the plant 18 and, as such, benefit the growth of plant 18. The watering shape 40 that is defined by the trench 34 can be have substantially any configuration. Generally, the size and shape of the watering shape 40 defined by trench 34 will be selected so as to most benefit the plant 18 and be reasonably easy to install system 10 in the planting area 24. Preferably, however, watering shape 40 will be continuous around plant hole 32, and plant 18 when disposed in plant hole 32, to allow the emitter line 32 to be placed along the length of trench 34 completely or nearly completely around the plant 18 in plant hole 32. Although the continuous shape of watering shape 40 around the plant hole 32 may generally be a square, rectangular or other shape, in the preferred embodiment watering shape 40 is circular with plant hole 32 at or substantially at a center location 42 of watering shape 42, as shown in FIGS. 1 through 5. As set forth below, a circular watering shape 40 for trench 34 facilitates use of apparatus 12 to simultaneously form plant hole 32 and trench 34.

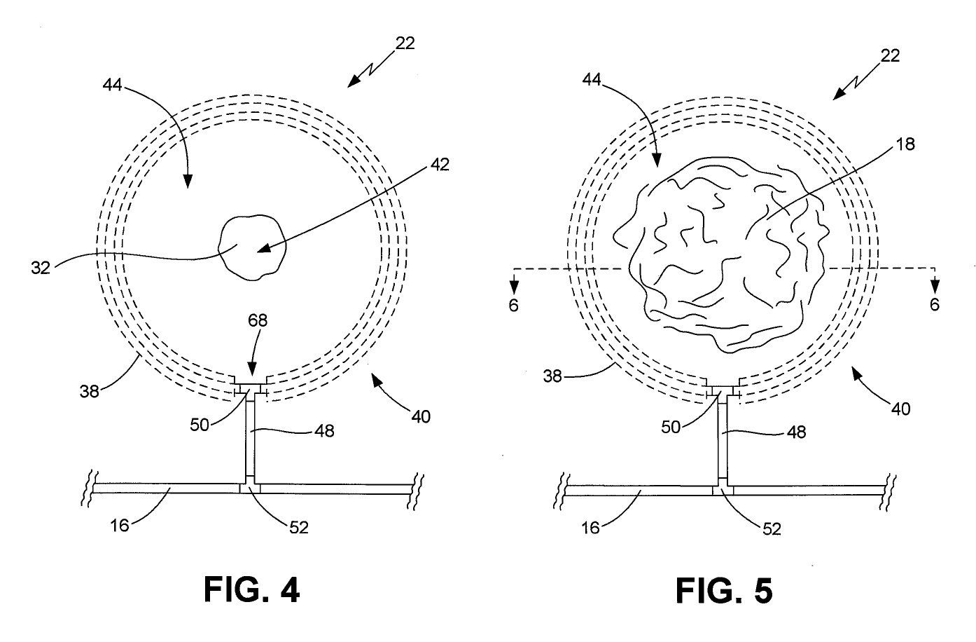

The plant location 22 of FIG. 2 is in its earliest stage of formation, with the plant location 22 only comprising the plant hole 32 and circular trench 34. In FIG. 2, the plant hole 32 and trench 34 are open, with the plant hole 32 being ready to receive plant 18 and the trench 34 being ready to receive the emitter line 36 (preferably disposed inside the perforated outer pipe 38) at the trench bottom 46 of trench 34. The plant hole 32 and trench 34 of the plant location 22 of FIG. 2 could be formed with apparatus 12 of FIG. 8. FIG. 3 shows the plant location 22 of the first row 26 of FIG. 1. In FIG. 3, the trench 34 remains open but it has the outer pipe 38, with the emitter line 36 shown as hidden therein, at the trench bottom 46. The outer pipe 38 is laid out in the same circular shape as watering shape 40 with a first end 64 and a second end 66 of the outer pipe 38 having a pipe gap 68 therebetween. The ends of the emitter line 36 are shown connected to first T-shaped line connector 50, which interconnects the emitter line 36 and the connecting line 48 that connects, via the second T-shaped line connector 52, to the secondary distribution line 16 and, via the primary distribution line 14, to the source of water 20 so water can be delivered to the plant 18 when it is placed inside plant hole 32 (as shown in FIG. 5). In FIG. 4, the trench 34 has been filled, typically with soil that was removed during the trench forming process. FIG. 4 corresponds to the plant locations 22 shown in the second row 28 of FIG. 1. In FIG. 5, which corresponds to plant locations 22 shown in the third row 30 of FIG. 1, the plant 18 (a tree) is inside the plant hole 32 and having watered delivered thereto, so as to facilitate the growing and producing of plant 18, from the source of water 20 by the distribution lines 14/16. FIG. 6 is a side view of a plant 18 shown growing at the plant location 22 with the filled in trench 34, shown as hidden lines, having the outer pipe 38 with the emitter line 36 therein to deliver water to the roots 54 of the plant 18.

As shown in FIGS. 1 and 3 through 5, the primary distribution lines 14, secondary distribution lines 16 and the connecting lines 48 are placed on top of ground surface 44 throughout the planting area 24. If desired, one or more of these lines could also be buried below the ground surface 44. In addition to increasing the cost of installing system 10, burying drip irrigation lines below the ground surface 44 has potential problems in many areas. One problem, is that if the lines are not buried deep enough, they are subject to being eaten through by gophers or other small mammals. Loss of flow through one of the distribution lines 14/16 will result in the disruption of water to all plants 18 downstream of the break in the line 14/16. As such, it is generally preferred to place the distribution lines 14/16 on top of the ground surface 44. If a line 14/16 fails, it can be more quickly located and it will be easier and less expensive to repair. The ability to repair or replace the connecting line 48 also generally favors placing this line 48 on top of the ground surface 44.

In the embodiment shown in FIGS. 1 and 3 through 6, emitter line 36 is shown as disposed inside the tubular outer pipe 38. Alternatively, the emitter line 36 can be placed directly inside the trench 34, without the use of outer pipe 38. Generally, however, this is not preferred. As with the distribution lines 14/16, burying any lines in the planting area 24 can subject the line to damage by gophers and other mammals. Although gophers can chew through many types of materials, if the problem is significant enough the user of system 10 can select a much stronger material, though it will typically be more expensive, for the outer pipe 38 to better protect the emitter line 36. In addition, burying the emitter line 36 without the use of the protective, perforated outer pipe 38 is likely to subject the emitter line 36 to damage from the roots 54 of the plant 18. As well known in the art, the roots 54 of the plants 18 can choke off the water flow by penetrating inside the emitter line 36 or by clamping around the emitter line 36. Outer pipe 38 can be selected so as to reduce the likelihood of these problems.

Although a wide variety of materials can be utilized for the various components of drip irrigation system 10 of the present invention, in a preferred embodiment standard drip irrigation components are utilized. For instance, the primary distribution line 14, secondary distribution line 16, emitter line 36 and connecting line 48 can all be standard and commonly utilized drip lines that are in place throughout the world. The outer pipe 38 can comprise a corrugated plastic pipe that is provided from the manufacturer with a plurality of perforations, such as that commonly utilized in leach field systems and the like. To avoid problems with gophers and the like, the trench bottom 46 of trench 34 should be sufficiently below the ground surface 44 that these pests are not likely to go through the outer pipe 38 and the emitter pipe 36 therein. The vertical portion of the emitter pipe 36 from the first T-shaped line connector 50 can also be protected by pipe, such as that utilized for outer pipe 38. Typically, the leach field type of perforated pipe is sufficiently strong, as designed, to prevent the intrusion of roots 54 into the outer pipe 38, where it could then damage the emitter pipe 36, or crushing from the roots 54 that could cut off the water flow through the emitter pipe 36.

In use, the user will initially prepare the planting area 24 as he or she would normally prepare the area for planting plants 18, typically by laying out the various plant locations 22 and distribution lines 14/16 and connecting these lines 14/16, typically primary distribution line 14, to the source of water 18. At each of the plant locations 22, the user forms the plant hole 32 that is to receive the plant 18 and forms the trench 34 that is to receive the emitter line 36 and, if used, outer pipe 38. In a preferred embodiment, the plant hole 32 and trench 34 are formed simultaneously utilizing the apparatus 12 shown in FIG. 8 and described below. As shown in FIGS. 2 and 6, the plant hole 32 is sized and configured to receive the plant and the trench 34 is configured at least substantially around the plant hole 32 so that water from the emitter line 32 will sufficiently deliver water to the roots 54 of the plant 18 when the plant 18 is planted in plant hole 32. Once the trench 34 is cut into the ground surface 44, the emitter line 36 and outer pipe 38 are placed into trench 34 along the length thereof, with emitter line 36 disposed inside the outer pipe 38, on top of the trench bottom 46, as shown in FIG. 3. At the pipe gap 68, defined by the ends 64/66 of the outer pipe 38, the ends of emitter line 36 are connected to first T-shaped line connector 50, which is connected to one end of the connecting line 48, as shown in FIGS. 3 through 5. As also shown in these figures, the opposite end of connecting line 48 is connected to second T-shaped line connector 52 that is also connected to the secondary distribution line 16. Either before or after connecting the emitter line 36 to the connecting line 48, the user will bury the emitter line 36, typically inside outer pipe 38, by filling up trench 34 with soil or other material, as shown in FIG. 4. As with prior art systems, the plant 18 is placed inside the plant hole 32 and the plant hole 32 is filled in around the plant 18 and water from the source of water 20 is allowed to flow through the distribution lines 14/16 to the plant locations 22. At the plant locations 22, the water will flow into the emitter line 36 and out the emitter apertures 56, typically through the discharge device 60, to the interior 61 of outer pipe 38. The water will flow out the discharge openings 58 in outer pipe 38 to the soil around the outer pipe 38, where trench 34 was formally located, and then to the soil around the roots 54 of the plant 18 to water the plant 18. As set forth above, in the preferred embodiment the discharge devices 60 are low flow rate emitters 62 that, as well known in the art, are placed at each of the emitter apertures 56 so that water is discharged out the emitter aperture 56 through the emitters 62. The flow rate and spacing between these emitters 62 are selected by the user to beneficially water the plants 18 with amount of water that is deemed to be most beneficial for the plants 18. As will be readily appreciated by those skilled in the art, a variety of different discharge devices 60 can be utilized with the system 10 to controllably transfer water from the emitter line 36 to the interior 61 of outer pipe 38.

Because the water from the source of water 20 is more specifically delivered to the roots 54 of plants 18, use of system 10 will provide more efficient and effective use of the water. This will reduce the amount of water utilized for watering plants 18 by as much as twenty to twenty-five percent or more in certain circumstances. Less water usage will lower the cost of providing water, whether it is purchased or pumped, and lower the overall cost of growing the plants 18 and producing the desired product therefrom. Another benefit of the system 10 of the present invention is that if there is a break in the emitter line 36 at one of the plant locations 22, this will not effect water delivery to the other plant locations 22 in the planting area 24. As is generally well known, most prior art drip irrigation systems place the discharge devices 60, such as the emitters 62, microsprinklers or the like, in or along the secondary distribution lines 16, which are placed along one side of the rows 26/28/30. For use with the emitters 62, these lines 16 are usually placed very close to the plant hole 32 where the plant 18 is located so that water will drip from the secondary distribution line 16 to the area around the plant 18. A portion of the water flow drips out to the ground and the remaining water flows through the emitter 62 to the next emitter 62 in the secondary distribution line 16. One problem with this prior art arrangement is that if one of the emitters 62 fail or become clogged, the line 16 and emitters 62 downstream of the failed emitter 62 will receive less or no water, which will lower the amount of water received by the plants 18 associated with those downstream emitters 62. The lower or no water delivery will stress the plants 18, which at the least will affect the growth rate of the plants 18 and/or lower the product production from the plants 18. The system 10 of the present invention avoids this problem. The emitter lines 36 having the emitters 62, or other discharge devices 60, are located inside the outer pipe 38 where they will less likely be subject to clogging. Even if one or more emitters 62 in an emitter line 36 fail, or even if the entire emitter line 36 itself fails, this failure will only affect that one plant 18, as they plant locations 22 are not in series. Unlike prior art systems, each of the plants 18 which are located downstream of the affected plant location 22 will continue to receive water from the secondary distribution lines 16, thereby avoiding turning the failure at one plant location 22 into a problem for other plant locations 22. Yet another benefit of the system 10 is that plant locations 22 can be located on the side of a hill or other elevated terrain. In prior art irrigation systems, if the plant location 22 is located on a hill or other elevated area any water that is discharged from an emitter, microsprinkler or other discharge device 60 will have a tendency to flow down the elevated area to low spots of the planting area, which is likely to deprive the plant 18 of the water it needs to grow and to produce the desired amount of product (such as nuts or fruits).

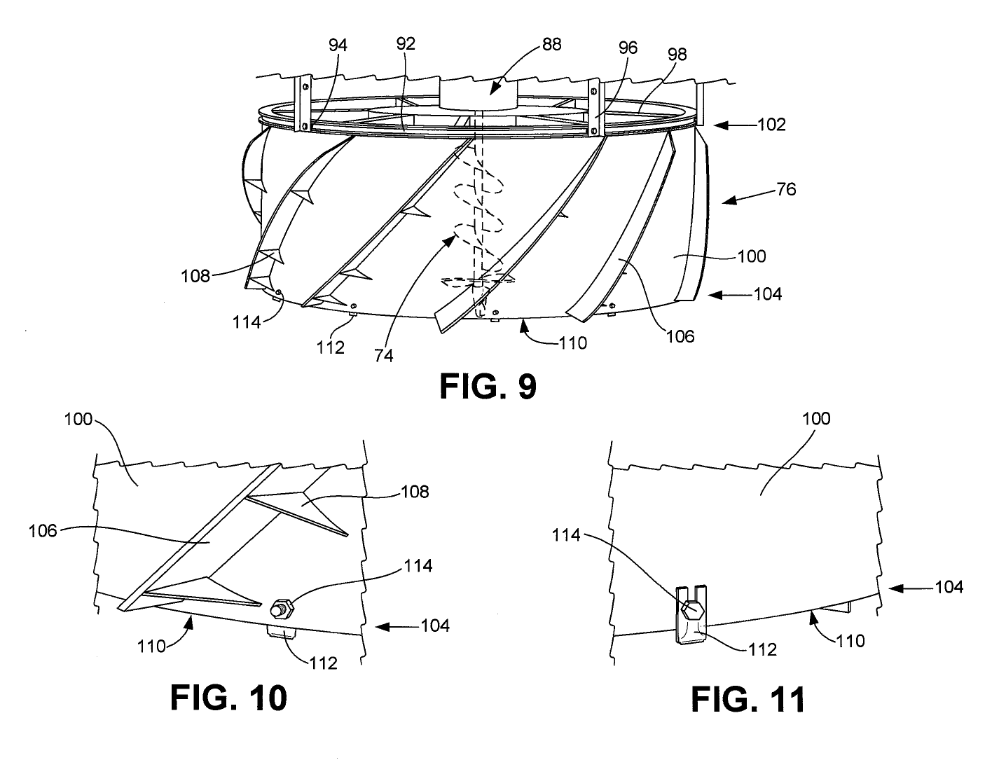

As set forth above, in a preferred embodiment of the system 10 of the present invention, the apparatus 12 shown in FIG. 8 is utilized to dig the plant hole 32 and cut the trench 34 in the ground surface 44 of the plant location 22. In this embodiment, the water shape 40 defined by the trench 34 is circular, as shown in FIGS. 1 through 5. As shown in FIG. 8, the apparatus 12 generally comprises a tool section 70 and an operating section 72. The tool section 70 provides the ability to dig the plant hole 32 and cut the trench 32 in the ground surface 44 and the operating section 72 provides the ability to move and control the operation of the apparatus 12. As shown in FIGS. 8 and 9, the tool section 70 has a plant hole forming tool 74 and a trench forming tool 76 that are configured to dig plant hole 32 and cut trench 34, respectively. In a preferred embodiment, these tools 74/76 operate simultaneously to dig the plant hole 32 and cut the trench 34. The operating section 72 is configured to move the apparatus 12 throughout the planting area 24 to each of the plant locations 22, position the apparatus 12 at the location for the plant hole 32 and trench 34 and operate the mechanisms that dig the plant hole 32 and trench 34.

As shown in FIG. 8, the tool section 70 has a frame 78 that rotatably supports both of the plant hole forming tool 74 and trench forming tool 76. The frame 78 comprises a plurality of frame members, such as frame members 80 and 82, that are selected so as to support the tools 74/76 and form the plant hole 32 and trench 34. Tool section 70 also has a vertical support mechanism 84 that is configured to support frame 78, to which plant hole forming tool 74 and trench forming tool 76 are rotatably supported, while raising and lowering the frame 78 so as to disengage and engage, respectively, the ground surface 44 at the plant location 22 with the tools 74/76 so as to dig the plant hole 32 and cut the trench 34. In one embodiment, the vertical support mechanism is has one or more hydraulic cylinders 86 that operate generally in a manner similar to the mast section of a fork lift or like apparatus. The tool section 70 also comprises a rotating mechanism 88 that is configured to rotate the tools 74/76, preferably together, relative to the frame 78 so as to simultaneously form the plant hole 32 and trench 34 at the plant area 22. In one embodiment, the rotating mechanism 88 comprises a powered gear device 90 operatively connected to both the plant hole forming tool 74 and trench forming tool 76 so as to rotate both of these tools 74/76, a slotted track 92 attached to the trench forming tool 76 and a plurality of rotating support bearings 94 that are each rotatably disposed in the slotted track 92 and connected to the frame 78 by a support bracket 96, as shown in FIGS. 8 and 9. In the embodiment shown in these figures, plant hole forming tool 74 is directly connected to the gear device 90 and the gear device 90 is connected to the trench forming tool 76 by a plurality of lateral support members 98.

In a preferred embodiment, the plant hole forming tool 74 is an auger or auger-like tool, as shown in FIG. 9. The auger configuration of the plant hole forming tool 74 is sized and configured to engage the ground surface 44 and dig the plant hole 32 therein so the plant hole 32 may receive the plant 18. Likewise, the trench forming tool 76 is sized and configured to engage the ground surface 44 and cut the trench 34 therein and form the trench bottom 46 so the trench 34 may receive the emitter line 36, which is preferably disposed in the outer pipe 38. In the embodiment shown in FIG. 8, the trench forming tool 76 comprises a solid cylindrically shaped tool body 100 having an upper end 102 and a lower end 104, as shown in FIGS. 8 and 9. As shown, the slotted track 92 is attached to or integral with the upper end 102 of the tool body 100. Attached to and extending outwardly from tool body 100 are a plurality of trench shaping blade members 106, as shown in FIGS. 8 through 10, which are sized and configured to shape the sides of the trench 34. In one embodiment, the blade members 106 are fixedly attached to or integral with tool body 100. In another embodiment, the blade members 106 are removably attached to tool body 100 so they may be repaired or replaced as necessary. As shown in these figures, the trench shaping blade members 106 can have a curvilinear arrangement on the tool body 100 so as to better engage and shape the sides of the trench 34. Preferably, a plurality of blade supports 108 are used to help support the blade members 106 as they are rotated around in and engage the sides of the trench 34.

In one embodiment of apparatus 12 of the present invention, the lower edge 110 of the tool body 100 is configured to cut into the ground surface 44 and form trench 34. In this embodiment, the lower edge 110 can comprise one or more cutting surfaces, either the entire lower edge 110 being a cutting surface or have a saw-like configuration. In the preferred embodiment of the apparatus 12, the trench forming tool 76 has a plurality of cutting blades 112 attached to the tool body 100 at or near the lower end 104 thereof which extend downwardly below the lower edge 110 of tool body 100, as shown in FIGS. 8 through 11. The cutting blades 112 are selected so as to be able to engage the ground surface 44, cut into ground surface 44 and keep cutting to form trench 34 to the desired depth at which the emitter line 36, as received in outer pipe 38, will be placed below the ground surface 44. In the preferred embodiment, the cutting blades 112 are removably connected to the tool body 100 with one or more connectors 114 so they may be replaced as they wear out from engaging ground surface 44 and cutting trench 34. In the embodiment shown, the connectors 114 are of the bolt/nut type of connectors and the cutting blades 112, as best shown in FIGS. 10 and 11. As will be readily appreciated by those skilled in the art, however, a wide variety of different types of connectors 114 can be utilized to removably connect the cutting blades 112 to the tool body 100.

The operating section 72 of apparatus 12 generally comprises an operator area or cab 116 in which the operator of apparatus 12 sits to move apparatus 12 in the planting area 24 from one plant location 22 to another. The operator area 116 comprises the controls for operating the vertical support mechanism 84 to raise and lower plant hole forming tool 74 and trench forming tool 76 to disengage and engage the ground surface 44 for forming the plant hole 32 and trench 34. The operating section 72 also comprises the power devices 118, such as the motor and hydraulic system, to provide power to the hydraulic cylinders 86 of the vertical support mechanism 84 to raise and lower the plant hole forming tool 74 and trench forming tool 76 and the rotating mechanism 88 to rotate these two tools 74/76 to form plant hole 32 and trench 34. The motor of the power devices 118 can be an internal combustion engine, diesel engine, electric engine or a variety of other motors. Operating section 72 also comprises a mobile carriage 120 that is configured to allow the apparatus 12 to move from one plant location 22 to another. The mobile carriage 120 of the apparatus 12 can comprise a tractor tread mechanism, such as that shown in FIG. 8, axles, transmission and other mechanisms that allow the apparatus 12 to move in the planting area 24. As will be readily appreciated by those skilled in the art, the mobile carriage 120 can have wheels or other mechanisms and/or be configured with a variety of different mobile systems. Alternatively, the apparatus 12 can be configured to be attached to another vehicle, such as a tractor, truck, harvester or the like and be moved from one plant location 22 to another.

In use, the apparatus 10 is moved to a plant location 22 with the center of the plant hole forming tool 74 (e.g., the auger) disposed over the center location 42 where the plant hole 32 is desired to be located, which will generally be in a row with other plant locations 22, as shown in FIG. 1. When apparatus 12 is being moved, the tool section 70 thereof is raised above the ground surface 44 so as to ensure that the tool section 70 does not contact the ground surface 44 while being moved. Once the apparatus 12 is in the proper location, the person in operator area 116 of apparatus 12 operates the vertical support mechanism 84 to lower the tool section 70 to the ground surface 44. The person in the operator area 116 then engages the rotating mechanism 88 to start rotating the plant hole forming tool 74 and trench forming tool 76 against the ground surface 44. At the same time, the vertical support mechanism 84 is further operated to lower the tool section 70 as it forms plant hole 32 and trench 34 until the desired depth below the ground surface 44 is reached. The operator then operates vertical support mechanism 84 to raise tool section 70 above the ground surface 44 so apparatus 12 can be moved to the next plant location 22 and the process repeated for the plant hole 32 and trench 34 at the new plant location 22. As stated above, in the preferred embodiment of the present invention, the apparatus 12 is configured to simultaneously rotate the plant hole forming tool 74 and trench forming tool 76 so as to simultaneously form plant hole 32 and trench 34. In other embodiments, the apparatus can be configured such that the plant hole 32 and trench 34 are or can be formed separately.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A drip irrigation system, comprising:
a source of water;
one or more distribution lines hydraulically connected to said source of water to distribute water throughout a planting area;
one or more plant locations in said planting area, each of said plant locations having a ground surface with a trench and a plant hole disposed in the ground surface, said plant hole having a plant received therein, said trench defining a trench bottom disposed below the ground surface and a watering shape disposed at least partially around said plant hole so as to be associated with said plant in said plant hole; and
an emitter line disposed along said watering shape of said trench at said trench bottom and hydraulically connected to at least one of said distribution lines, said emitter line configured to discharge water into said trench at said plant location so as to distribute water to one or more roots of said plant.

2. The drip irrigation system of claim 1, wherein said emitter line has one or more discharge apertures, each of said discharge apertures sized and configured to discharge water from said emitter line into said trench so as to distribute water to said roots of said plant.

3. The drip irrigation system of claim 2, wherein said emitter line is disposed in an outer pipe positioned on said trench bottom so as to discharge water into an interior of said outer pipe through said discharge apertures, said outer pipe having one or more discharge openings therein to allow water to flow from said interior of said outer pipe to said roots of said plant.

4. The drip irrigation system of claim 1, wherein said emitter line has a discharge device at each of said emitter apertures.

5. The drip irrigation system of claim 4, wherein said discharge device is a low flow rate emitter.

6. The drip irrigation system of claim 1, wherein said watering shape defined by said trench is circular.

7. The drip irrigation system of claim 6, wherein said plant hole is disposed substantially at or near a center location of said watering shape.

8. The drip irrigation system of claim 1, wherein said emitter line is disposed in an outer pipe positioned on said trench bottom so as to discharge water into an interior of said outer pipe, said outer pipe having one or more discharge openings therein to allow water to discharge from said interior of said outer pipe to said roots of said plant.

9. The drip irrigation system of claim 1, wherein said trench and said plant hole were formed simultaneously by an apparatus having a trench forming tool configured to cut said trench in said ground surface and a plant hole forming tool configured to dig said plant hole out in said ground surface.

10. A drip irrigation system in combination with a planting area having a plurality of plants, said drip irrigation system comprising:
a source of water;
one or more distribution lines hydraulically connected to said source of water to distribute water throughout said planting area;
one or more plant locations in said planting area, each of said plant locations having a ground surface with a trench and a plant hole disposed in the ground surface, said plant hole having one of said plants therein, said trench defining a trench bottom disposed below the ground surface and a circular watering shape disposed around said plant hole and configured so as to be associated with one or more roots of said plant in said plant hole;
an outer pipe buried along said watering shape of said trench at said trench bottom so as to substantially encircle said plant hole, said outer pipe having a plurality of discharge openings therein to allow water to flow from an interior of said outer pipe into said trench and to said roots of said plant; and
an emitter line disposed in said interior of said outer pipe and hydraulically connected to at least one of said distribution lines, said emitter line configured to discharge water into said interior of said outer pipe so as to distribute water to said roots of said plant through said discharge openings in said outer pipe.

11. The drip irrigation system of claim 10, wherein said emitter line has one or more discharge apertures, each of said discharge apertures sized and configured to discharge water from said emitter line into said interior of said outer pipe.

12. The drip irrigation system of claim 11, wherein said emitter line has a discharge device at each of said emitter apertures.

13. The drip irrigation system of claim 12, wherein said discharge device is a low flow rate emitter.

14. The drip irrigation system of claim 10, wherein said plant hole is disposed substantially at or near a center location of said watering shape.

15. The drip irrigation system of claim 10, wherein said trench and said plant hole were formed simultaneously by an apparatus having a trench forming tool configured to cut said trench in said ground surface and a plant hole forming tool configured to dig said plant hole out in said ground surface.

16. An apparatus for installing a drip irrigation system at a plant location in a planting area, said apparatus comprising:
a frame having a plurality of frame members;
a plant hole forming tool rotatably supported by said frame, said plant hole forming tool configured to engage a ground surface at said plant location and form a plant hole in said ground surface, said plant hole sized and configured to receive a plant therein, said drip irrigation system configured to deliver water to said plant through one or more distribution lines;
a trench forming tool rotatably supported by said frame, said trench forming tool configured to engage said ground surface at said plant location and form a trench substantially around said plant hole, said trench having a trench bottom to receive an emitter line hydraulically connected to at least one of said one or more distribution lines so as to discharge water into said trench, said trench defining a watering shape;
a rotating mechanism supported by said frame and operatively connected to each of said plant hole forming tool and said trench forming tool, said rotating mechanism configured to rotate said plant hole forming tool and said trench forming tool relative to said frame; and
a vertical support mechanism interconnecting to said frame and an operating section of said apparatus, said vertical support mechanism configured to raise and lower said frame so as to respectively disengage or engage said plant hole forming tool and/or said trench forming tool with said ground surface.

17. The apparatus of claim 16, wherein said trench forming tool has a circular shaped tool body to define said watering shape as circular, said trench forming tool comprising one or more trench shaping blade members extending outwardly from said tool body, said trench shaping blade members selected so as to shape said trench.

18. The apparatus of claim 17, wherein said trench forming tool further comprises one or more cutting blades at a lower end of said tool body, each of said cutting blades extending below a lower edge of said tool body so as to cut said trench into said ground surface.

19. The apparatus of claim 18, wherein said cutting blades are removably attached to said tool body.

20. The apparatus of claim 16, wherein said operating section of said apparatus comprises an operator area configured to operate said rotating mechanism and said vertical support mechanism, a power device configured to supply power to said apparatus and to said rotating mechanism and said vertical support mechanism and a mobile carriage configured to allow said apparatus to move to said plant location.
